(19) United States
(12) Patent Application Publication
(10) Pub. No.: US 2009/0022064 A1
(43) Pub. Date: Jan. 22, 2009

(54) Method and apparatus for monitoring multicast bandwidth to a user

(76) Inventors: Moshe Oron, San Rafael, CA (US); David P. Fredrickson, Annandale, VA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/975,699

(22) Filed: Oct. 19, 2007

Related U.S. Application Data
(60) Provisional application No. 60/959,994, filed on Jul. 18, 2007.

(51) Int. Cl. G06F 11/00

(52) U.S. Cl. 370/253

(57) ABSTRACT

A method and apparatus of monitoring multicast bandwidth to user may include monitoring quantity of a multicast group flowing to a user and converting the quantity to bandwidth. The bandwidth may be summed with bandwidth of other multicast groups being monitored for the user to determine a total bandwidth flowing to the user. The method and apparatus may perform an action based on the total bandwidth. A counter may be associated with an identified multicast group requested to be received by the user and monitoring the quantity of the multicast group may include counting a number of bits bytes or other metric of the multicast group. Determining bandwidth allows the system to prevent users from exceeding their allocated bandwidth based on their service level agreement (SLA). The system may also identify dropped multicast group(s) and may also identify bandwidth utilization by reporting a user's bandwidth consumption.

### RELATED APPLICATION

This application claims the benefit of U.S. Provisional Application No. 60/959,994, filed on Jul. 18, 2007. The entire teachings of the above application are incorporated herein by reference.

### BACKGROUND OF THE INVENTION

Early implementation of access networks were deployed as point-to-point networks. With single end nodes, it is relatively easy to determine multicast bandwidth across a point-to-point connection by, for example, maintaining a centralized list of each multicast group's bandwidth. Identifying a dropped multicast group and determining a multicast group's bandwidth utilization is also a relatively straightforward process as there are only two network nodes.

### SUMMARY OF THE INVENTION

An example method and corresponding apparatus of monitoring multicast bandwidth to a user may include monitoring quantity of a multicast group flowing to a user and converting the quantity to bandwidth. The bandwidth may then be summed with bandwidth of other multicast groups being monitored for the user to determine a total bandwidth flowing to the user. An action based on the total bandwidth may be performed.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram of an example Passive Optical Network (PON) employing an embodiment of the invention;

FIG. 2 is a network diagram of an example Digital Subscriber Line Access Multiplexer (DSLAM) employing an embodiment of the invention;

FIG. 3 is a network diagram of an example portion of a PON in which an Optical Network Terminal (ONT) is configured to monitor multicast bandwidth;

FIG. 4 is a block diagram on a Multicast Bandwidth Monitor (MBM) according to an example embodiment of the invention;

FIG. 5 is a flow diagram performed in accordance with an example embodiment of the invention; and

FIG. 6 is a flow diagram illustrating actions performed in accordance with an example embodiment of the invention.

### DETAILED DESCRIPTION OF THE INVENTION

A description of example embodiments of the invention follows.

As service demands have increased, network providers have begun deploying point-to-multipoint passive optical network (PON) architectures. Determining IPTV multicast bandwidth used by individual user or subscriber may be required since the service provider may offer service packages that differ in supported bandwidth. However, determining the bandwidth is not a straightforward process because of replication of multicast packets.

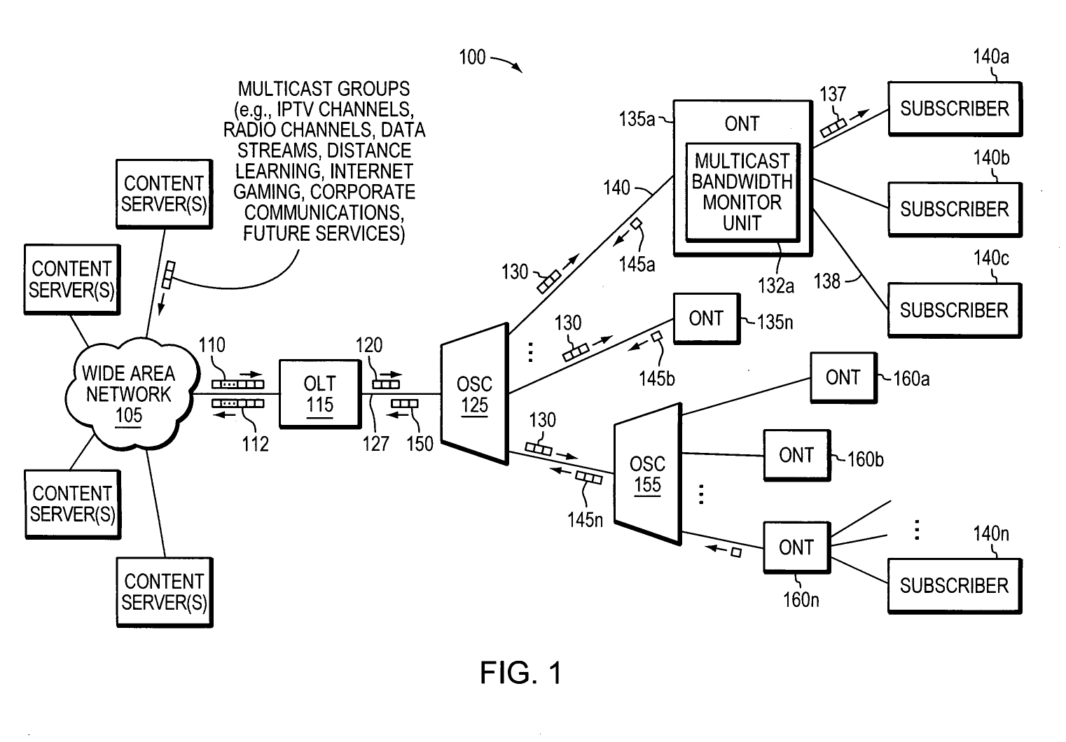

FIG. 1 is a network diagram of a passive optical network (PON) 100 illustrating aspects of an example embodiment of the invention. The PON 100 includes an optical line terminal (OLT) 115, an optical splitter/combiner (OSC) 125, and at least one optical network unit (ONT) 135a-n. The ONT 135a-n may be in optical communication with multiple subscribers 140 that may be connected to end user equipment, such as a set-top box (not shown). The ONT 135a-n may also include a multicast bandwidth monitor 132a. Data communications 110 may be transmitted to the OLT 115 from a wide area network (WAN) 105.

“Data” as used herein refers to voice, video, analog, or digital data. Also note that “user” and “subscriber” are used interchangeably hereinafter and “multicast group” and “TV channel” may also be used interchangeably.

Communication of downstream data 120 and upstream data 150 transmitted between the OLT 115 and the ONTs 135a-n may be performed using standard communications protocols known in the art. For example, multicast may be used to transmit the downstream data 120 from the OLT 115 to the ONTs 135a-n, and time division multiple access (TDMA) for transmitting the upstream data 150 from an individual ONT 135a-n back to the OLT 115. Note that the downstream data 120 is power divided by the OSC 125 into downstream data 130 matching the downstream data 120 “above” the OSC 125 but with power reduced proportionally to the number of paths onto which the OSC 125 divides the downstream data 120. It should be understood that the terms downstream data 120, 130 refers to optical traffic signals that travel from the OLT 115 to the ONT(s) 135a and subscriber(s) 140a-n, and upstream data 145a, 150 are optical traffic signals that typically travel from the subscribers 140a and ONTs 135a-n to the OLT 115 via optical communications paths such as optical fibers links 138, 140, 127.

The PON 100 may be deployed for fiber-to-the-premise (FTTP), fiber-to-the-curb (FTTC), fiber-to-the-node (FTTN), and other fiber-to-the-X (FTTX) applications. The optical fiber 127 in the PON 100 may operate at bandwidths such as 155 mega bits per second (Mbps), 622 Mbps, 1.25 giga bits per second (Gbps), and 2.5 Gbps or other bandwidth implementations. The PON 100 may incorporate asynchronous transfer mode (ATM) communications, broadband services such as Ethernet access and video distribution, Ethernet point-to-multipoint topologies, and native communications of data and time division multiplex (TDM) formats or other communications suitable for a PON 100. ONTs 140, may receive and provide communications to and from the PON 100 and may be connected to video devices, Ethernet units, digital subscriber lines, Internet Protocol telephones, computer terminals, wireless access, as well as any other conventional customer premise equipment.

The OLT 115 generates, or passes through, downstream communications 120 to an OSC 125. After flowing through the OSC 125, the downstream communications 120 are transmitted as power reduced downstream communications 130 to the ONTs 135a-n where each ONT 135a-n may filter and replicate data 130 intended for a particular subscriber 140a-c. The downstream communications 120 may also be transmitted to, for example, another OSC 155 where the downstream communications 120 are again split and transmitted to additional ONT(s) 160a-n and subscriber(s) 140n.

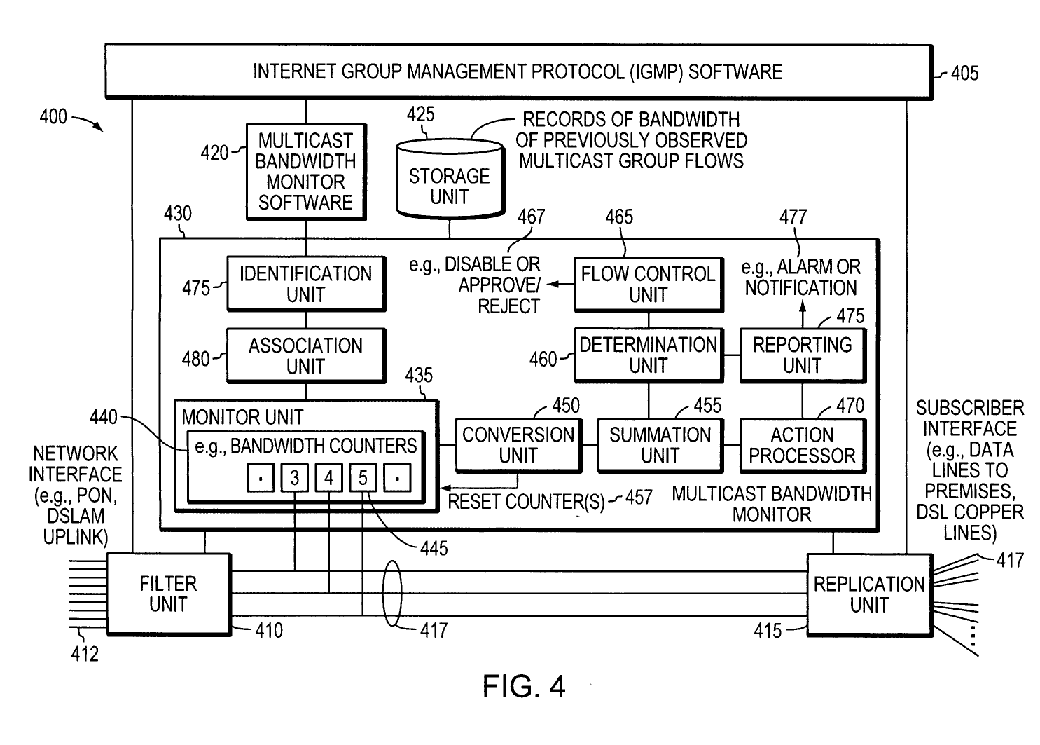

Data communications 137 may be further transmitted to and from, for example, subscriber(s) 140a-n in the form of voice, video, data, and/or telemetry over copper, fiber, or other suitable connection 138 as known to those skilled in the art. The multicast bandwidth monitor unit 132a may be employed to determined bandwidth of multicast data communications (described below in further detail in reference to FIG. 4). The ONTs 135a-n may transmit upstream communication signals 145a-n back to the OSC 125 via fiber connections 133 using transmission protocols known in the art, such as Internet Group Management Protocol (IGMP). The OSC 125, in turn, combines the ONT's 135a-n upstream signals 145a-n and transmits a combined signal 150 back to the OLT 115 which may, for example, may employ a time division multiplex (TDM) protocol to determine from which ONTs 135a-n portions of the combined signal 150 are received. The OLT 115 may further transmit the communication signals 112 to a WAN 105.

Communications between the OLT 115 and the ONTs 135a-n occur using a downstream wavelength, for example 1490 nanometer (nm), and an upstream wavelength, for example 1310 nm. The downstream communications 120 from the OLT 115 to the ONTs 135a-n may be provided at 2.488 Gbps, which is shared across all ONTs. The upstream communications 145a-n from the ONTs 135a-n to the OLT 115 may be provided at 1.244 Gbps, which is shared amongst all ONTs 135a-n connected to the OSC 125. Other communication data rates known in the art may also be employed.

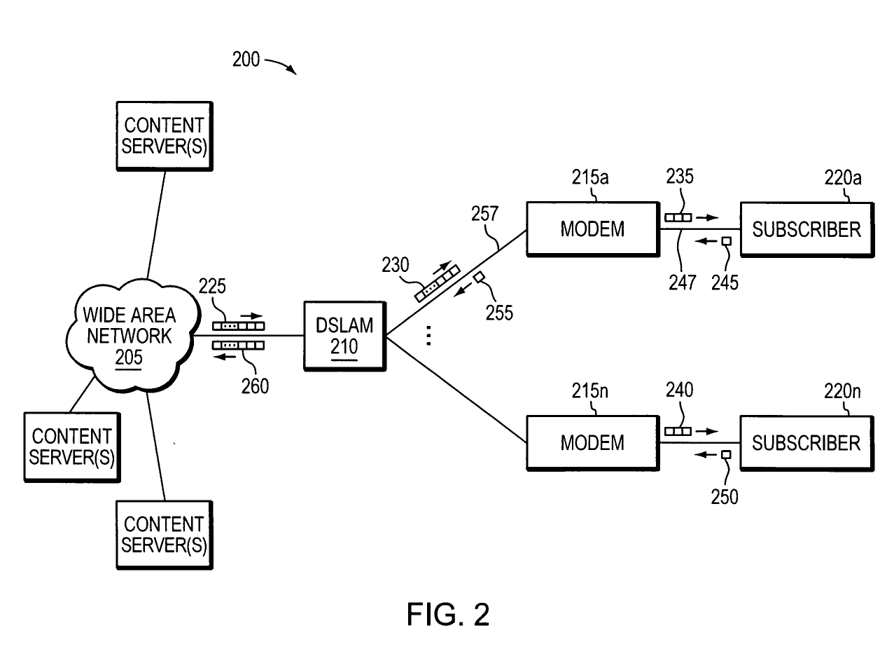

FIG. 2 is a network diagram 200 depicts a Digital Subscriber Line Access Multiplexer (DSLAM) 200 illustrating aspects of an example embodiment of the invention. Rather than the point to multipoint architecture depicted in the FIG. 1, the network diagram 200 shown in FIG. 2 illustrates a point-to-point network architecture. The network may include a DSLAM 210, at least one electrical device, such as a Digital Subscriber Line (DSL) modem 215a-n, and at least one end node, such as a subscriber premises 220a-n. The DSLAM 210 may be in electrical communication with the modem 215a-n via twisted-pair copper wires 257, and the modem 215a-n may in turn be connected to a subscriber 220a-n via another set of twisted-pair copper wires 247.

Multicast communication signals 225, 260 may be transmitted to and from the DSLAM 210 and a WAN 205. The DSLAM 210, transmits the communication signals 230 to the modem(s) 215a-n via copper lines 257. The communications signals 235 continue to propagate toward a receiving network node, such as a set-top box (not shown) at the subscribers premises 220a-n. The DSLAM 210 is a network device that may be located in a central office or may be deployed closer to the subscriber's 220a-n neighborhood, and may connect multiple DSLs to the Internet via, for example, the WAN 205.

Note that the preceding network architectures (PON and DSLAM) are presented for the purpose of illustrating a network in which an embodiment of the invention may be deployed. These network architectures are not intended to limit the invention to a particular architecture but are instead presented for the purposes of describing a method and apparatus of monitoring multicast bandwidth to a user. The invention may also be deployed in alternative network architectures that transmit multicast data communications.

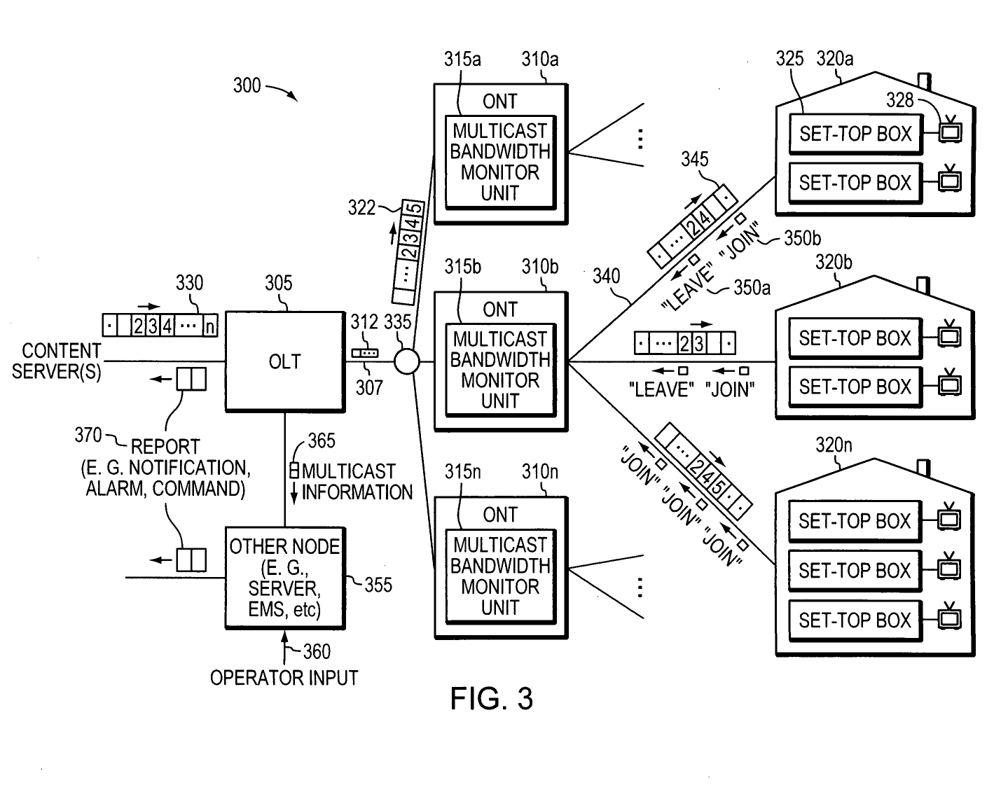

FIG. 3 is a block diagram of an example portion of a PON 300 in which an Optical Network Terminal (ONT) is configured to monitor multicast bandwidth to a user according to an example embodiment of the invention. The example PON may include an OLT 310a-n, an OSC 335, at least one ONT 310a-n, and at least one subscriber 320a-n. The ONT 310a-n may further include a multicast identification unit 315a-n to monitor multicast bandwidth to a subscriber premises 320a-n. The at least one subscriber premises may include electrical equipment such as a set-top box 325 that may communicate, for example, Internet Protocol TV (IP TV) which may be further connected to, for example, a television 328 for viewing IP TV content.

In operation, the OLT 305 may receive multicast group communications signals 330 and further transmit the multicast group communications signals 312 to the OSC 335. After splitting and passing through the OSC 335, the communications signals 322 continue to flow on toward the ONTs 310a-n. The ONTs may use the multicast bandwidth monitor unit(s) 315a-n to determine a bandwidth of each unique multicast group contained in the received communications signals 322 that is requested by one of the ONT's subscribers i.e., multicast groups that the ONT forwards to at least one subscriber. The multicast bandwidth monitor unit(s) 315a-n will be described below in further detail with reference to FIG. 4. The ONTs may transmit multicast group signals 345 to subscriber premises 320a-n where the signal received at each subscriber 320a-n typically contains the multicast groups requested by that particular subscriber. Note that “push” content not specifically requested by the subscriber may also flow to the subscriber, as is known in the art.

Subscribers 320a-n may request to view particular multicast group by issuing an Internet Group Management Protocol (IGMP) “join” message or may request to stop viewing a multicast group by issuing an IGMP “leave” message. For example, a subscriber 320a may wish change a channel, say from channel 5 to channel 4, by issuing an IGMP “leave” 350a message to leave the multicast group representing channel 5 and an IGMP “join” 350b message to join a multicast group representing channel 4. Thus, as shown in FIG. 3, one subscriber 320a may view multicast groups representing channels 2 and 4, another subscriber 320b may view multicast groups representing channels 2 and 3, and another subscriber 320n may view multicast groups representing channels 2, 4, and 5 by issuing the appropriate IGMP “leave” 350a and “join” 350b messages.

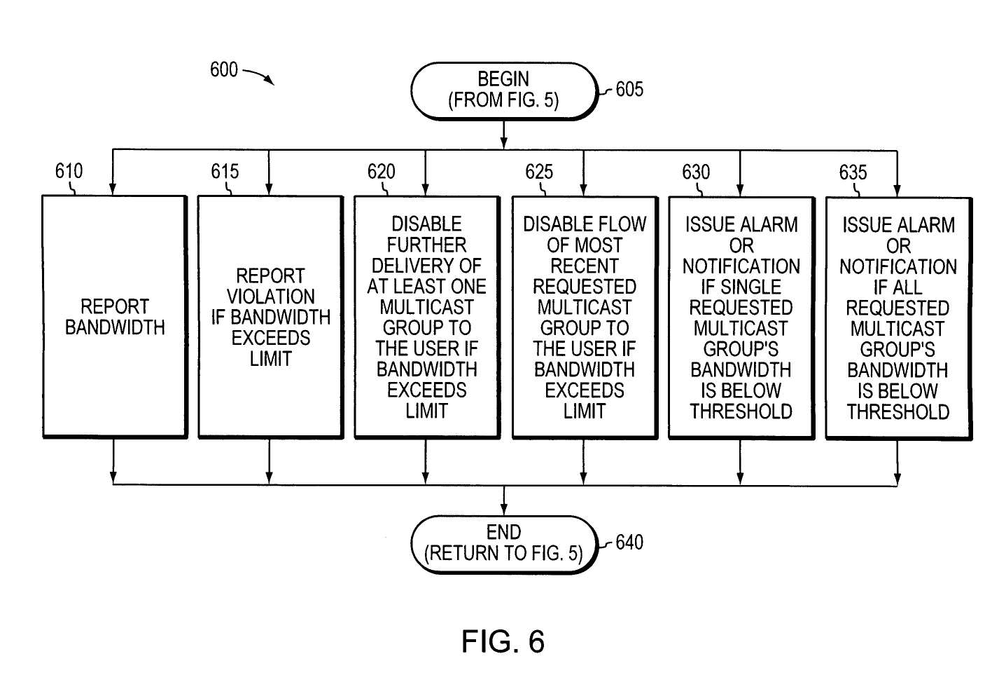

The ONTs 310a-n may perform an action, such as issuing a notification or alarm report 370 based on a determined bandwidth measurement, and may further communicate the notification or alarm back to a system operator (discussed below in further detail in reference to FIG. 6). Multicast information 365 may also be communicated to other nodes, such as an Element Management System (EMS) 355 where the EMS may generate a notification or alarm 370. The EMS 355 may also be used to provide operator input 360 for use with the multicast bandwidth monitor units 315a-n. For example, an operator may provide a threshold and/or limit value to compare against the determined bandwidth, the results of which may further determine a particular action taken by the system based upon compared result.

FIG. 4 is a detailed block diagram 400 employing an example embodiment of the invention. A method and system of monitoring multicast bandwidth to a user includes monitoring quantity of a multicast group flowing to a user and converting the quantity to bandwidth. The bandwidth may be summed with bandwidth of other multicast groups flowing to the user to determine a total bandwidth flowing to the user. The technique may perform an action based on the total bandwidth. The technique may further include identifying a multicast group requested to be received by the user, associating a counter with a multicast group requested to be received by the user, and where monitoring the quantity of the multicast group data includes counting, using the counter, a number of bits, bytes, or other metric of the multicast group.

In an alternative embodiment of the invention, converting the quantity of multicast group data to bandwidth includes reading a value in the counter and resetting the counter to begin further counting. The counter may be reset or cleared on a periodic, aperiodic, event driven, or on-demand basis. The bandwidth measurement may be improved by averaging at least two measurement results, for example, averaging five bandwidth determinations over five consecutive counting cycles. The number of counters used for counting may be at least an order of magnitude fewer than the number of multicast groups available to the user.

In another example embodiment, summing the bandwidth further includes summing the bandwidth of all multicast groups received by a user within a group of users, for respective determinations of total bandwidth for each of the users. The group of users may be, for example, all users connected to the same ONT. Performing an action may include reporting the total bandwidth. The technique may further include determining whether the total bandwidth exceeds a limit configured for the user and reporting a violation in an event the total bandwidth exceeds the limit. The technique may also include determining whether the total bandwidth exceeds the limit, and disabling further delivery of a least one multicast group to the user in an event the total bandwidth exceeds the limit. Alternatively, the technique may include determining whether the total bandwidth exceeds a limit and disabling flow of a most recent requested multicast group to the user in an event the total bandwidth exceeds the limit.

In yet another example embodiment, the technique may further include performing an action which may include issuing an alarm or notification in an event the bandwidth for a single requested multicast group is below a threshold or the bandwidth for all requested multicast groups is below or above a threshold. Performing the action may also include replying to inquiries with an indication of the total bandwidth flowing to the user.

In still another example embodiment, the technique may further include updating a set of multicast groups sent to the user based on join or leave messages, associating a counter to each multicast group sent to the user, accessing a record of the bandwidth of the multicast groups previously flowed to the user, determining the user's total bandwidth by periodically summing bandwidth of all multicast groups requested by the user, and approving or rejecting the request as a function of a total bandwidth of the multicast groups to flow to the user if the request were to be approved.

Embodiments of the invention may be employed in a number of different network architectures as an ONT in a PON, or used in a DSLAM in a DSL network. However, it should be noted that these example networks are for illustrative purposes only and embodiments of the invention should not be considered limited to these network architectures.

Continuing to refer to FIG. 4, an ONT (not shown) employing an example embodiment of the invention may include Internet Group Management Protocol (IGMP) software 405, multicast bandwidth monitor software 420, storage unit 425, filter unit 410, replication unit 415, and multicast bandwidth monitor unit 430.

The filter unit 410 may be connected to a network interface, such as a PON, or DSLAM uplink. The filter unit 410 may be configured to examine incoming multicast groups, and based on join or leave messages communicated to the filter unit 410 from the IGMP software 405, multicast groups may be filtered (i.e., not forwarded), or, if requested by the subscriber, forwarded to the replication unit 415. For all requested multicast groups, the replication unit 415 replicates and forwards a copy of the multicast group communications signals to a subscriber interface (e.g., data lines to premises in the case of PON, or DSL copper lines in the case of a DSLAM) via connections 417. The storage unit 425 may store records of bandwidth of previously observed multicast group flows.

The multicast bandwidth monitor 430 may contain an identification unit 475, in association unit 480, and a monitor unit 435. The identification unit 475 in conjunction with the multicast bandwidth monitor software 420 may identify a multicast group requested to be received by the user (e.g., and IGMP join message). The association unit 480 may assign or associate a counter with a multicast group requested to be received by the user. A bandwidth counter 445 may be associated with each multicast group 417 requested to be received by a subscriber connected to the ONT.

The multicast bandwidth monitor may monitor the quantity of the multicast groups data by, for example, using counters to count a number of bytes bits or other metric of the multicast group. Advantageously, the number of bandwidth counters 445 may be much less than the number of multicast groups 412 that a user may choose from. Thus, the number of counters may be as few as the number of multicast groups being requested by the users connected to the ONT even though a user may be able to select from hundreds or thousands multicast groups.

The conversion unit 450 may convert the quantity of data to bandwidth by reading a value in the counter and dividing the value by a time interval (e.g., 1 second). The counter may also be reset 457 within the same or next instruction cycle to immediately begin further counting. The summation unit 455 may further include summing the bandwidth of all multicast groups received by each of the multiple users to determine a total bandwidth value for each one of the multiple users connected to the ONT. The action processor 470 may perform an action such as employing the reporting unit 475 to report the total bandwidth for each user, a group of users, or all users.

The determination unit 460 may determine whether the total bandwidth exceeds a limit or threshold configured for a user. In the event the total bandwidth exceeds the limit, the reporting unit 475 may report a violation indicating such. In addition, or alternatively, the flow control unit 465 may disable further delivery of a least one multicast group to the user. The group disabled may be the most recently requested multicast group by the user. The action processor 470 may issue an alarm or notification 477 in the event either the bandwidth for a single received group is below a threshold or the bandwidth for all requested groups is below a threshold. The action processor 470 may also reply to inquiries with an indication of the total bandwidth flowing to the user(s).

The block diagrams of FIGS. 3 and 4 are merely representative and more or fewer units may be used, and operations may not necessary be divided up as described herein. Also, a processor executing software may operate to execute operations performed by the units. It should be understood that the block diagrams may, in practice, be implemented in hardware, firmware, or software. If implemented in software, the software may be any form capable of performing operations described herein, stored on any form of computer readable-medium, such as RAM, ROM, CD-ROM, and loaded and executed by a general purpose or application specific processor capable of performing operations described herein.

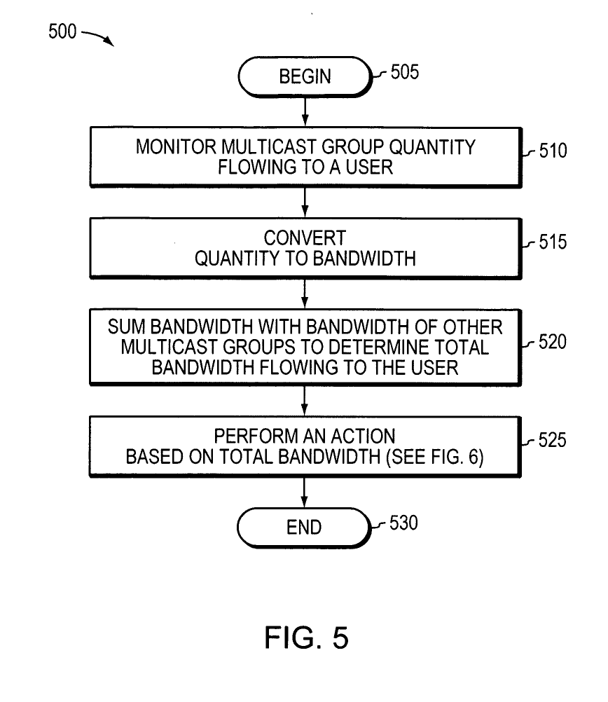

FIG. 5 is an example flow diagram of a process 500 illustrating an example embodiment of the invention. The process 500 starts (505) and monitors multicast group quantity flowing to a user, and may convert quantity to bandwidth (515). The bandwidth may be summed with bandwidth of other multicast groups to determine the total bandwidth flowing to the user (520). The process 500 may perform an action based on total bandwidth (525), and after performing the action may end (530).

FIG. 6 is a flow diagram of a process 600 depicting various actions that be performed (as shown in FIG. 5, sequence 525) by example embodiments of the invention. The process 600 begins (605) and may report bandwidth (610), or may report a violation if the bandwidth exceeds a limit (515). The process 600 may disable further delivery of at least one multicast group to the user if the bandwidth exceeds the limit (620) or may disable flow of a most recently requested multicast group to the user if the bandwidth exceeds the limit (625). The process 600 may issue an alarm or notification if a single requested group's bandwidth is, for example, below or above a threshold (or other determinable condition or event) (630). Alternatively, or in addition, the process 600 may issue an alarm or notification if the requested bandwidth is below a threshold (635) for all requested groups. The process 600 may then end (640) and return to sequence (525) of FIG. 5.

Some or all of the flow 500 of FIG. 5 or flow 600 of FIG. 6 may be implemented in hardware, firmware, or software. If implemented in software, the software may be (i) stored locally with the OLT, the ONT, or some other remote location such as the EMS, or (ii) stored remotely and downloaded to the OLT, the ONT, or the EMS during, for example, start 505. The software may also be updated locally or remotely. To begin operations in a software implementation, the OLT, the ONT, or EMS may load and execute the software in any manner known in the art.

It should be apparent to those of ordinary skill in the art that methods involved in the invention may be embodied in a computer program product that includes a computer usable medium. For example, such a computer usable medium may consist of a read-only memory device, such as a CD-ROM disk or convention ROM devices, or a random access memory, such as a hard drive device or a computer diskette, having a computer readable program code stored thereon.

Although described in reference to a PON and DSLAM, the same or other example embodiments of the invention may be employed in an active optical network, data communications network, wireless network (e.g., between handheld communications units and a base transceiver station), or any other type of communications network.

While this invention has been particularly shown and described with references to example embodiments thereof, it will be understood by those skilled in the art that various changes in form and details may be made therein without departing from the scope of the invention encompassed by the appended claims.

What is claimed is:

1. A method of monitoring multicast bandwidth to a user, comprising:
monitoring quantity of a multicast group flowing to a user;
converting the quantity to bandwidth;
summing the bandwidth with bandwidth of other multicast groups flowing to the user to determine a total bandwidth flowing to the user; and
performing an action based on the total bandwidth.

2. The method according to claim 1 further including:
identifying a multicast group requested to be received by the user;
associating a counter with a multicast group requested to be received by the user; and
wherein monitoring the quantity of the multicast group includes counting, using the counter, a number of bits, bytes, or other metric of the multicast group.

3. The method according to claim 2 wherein converting the quantity to bandwidth includes reading a value in the counter and resetting the counter to begin further counting.

4. The method according to claim 2 wherein the number of counters used for counting is at least an order of magnitude fewer than the number of multicast groups available to the user.

5. The method according to claim 2 further including:
clearing the counter on a periodic, aperiodic, event driven, or on-demand basis; and
adjusting the bandwidth measurement by averaging at least two bandwidth measurements.

6. The method according to claim 1 wherein summing the bandwidth further includes summing the bandwidth for each user across multiple different users for respective determinations of total bandwidth for each user.

7. The method according to claim 1 wherein performing the action includes reporting the total bandwidth.

8. The method according to claim 1 wherein performing the action includes:
determining whether the total bandwidth exceeds a limit configured for the user; and
reporting a violation in an event the total bandwidth exceeds the limit.

9. The method according to claim 1 wherein performing the action includes:
determining whether the total bandwidth exceeds a limit; and
disabling further delivery of at least one multicast group to the user in an event the total bandwidth exceeds the limit.

10. The method according to claim 1 wherein performing the action includes:
determining whether the total bandwidth exceeds a limit; and
disabling flow of a most recently requested multicast group to the user in an event the total bandwidth exceeds the limit.

11. The method according to claim 1 wherein performing the action includes issuing an alarm or notification in an event the bandwidth for a requested multicast group is below a threshold, or above a threshold.

12. The method according to claim 1 wherein performing the action includes issuing an alarm or notification in an event the bandwidth for all requested multicast groups is below a threshold.

13. The method according to claim 1 wherein performing the action includes replying to inquiries with an indication of the total bandwidth flowing to the user.

14. The method according to claim 1 further including:
updating a set of multicast groups sent to the user based on join or leave messages;
associating a counter to each multicast group sent to the user;
accessing a record of the bandwidth of the multicast groups previously flowed to the user;
determining the user's total bandwidth by periodically summing bandwidth of all multicast groups requested by the user; and
approving or rejecting the request as a function of a total bandwidth of the multicast groups to flow to the user if the request were to be approved.

15. The method according to claim 1 used in an Optical Network Terminal (ONT) in a Passive Optical Network (PON).

16. The method according to claim 1 used in a Digital Subscriber Line Access Multiplexer (DSLAM) in a Digital Subscriber Line (DSL) network.

17. An apparatus for monitoring multicast bandwidth to a user, comprising:
a monitor unit configured to monitor a quantity of a multicast group flowing to a user;
a conversion unit configured to convert the quantity to bandwidth;
a summation unit configured to sum the bandwidth with bandwidth of other multicast groups flowing to the user to determine a total bandwidth flowing to the user; and
an action processor configured to perform an action based on the total bandwidth.

18. The apparatus according to claim 17 further including:
an identification unit configured to identify a multicast group requested to be received by the user;
an association unit configured to associate a counter with a multicast group requested to be received by the user; and
wherein the monitor unit is configured to monitor the quantity of the multicast group by counting, using the counter, a number of bits, bytes, or other metric of the multicast group.

19. The apparatus according to claim 18 wherein the conversion unit is configured to convert the quantity to bandwidth by reading a value in the counter and resetting the counter to begin further counting.

20. The apparatus according to claim 18 wherein the number of counters used to count is at least an order of magnitude fewer than the number of multicast groups available to the user.

21. The apparatus according to claim 18 further wherein the monitor unit is configured to clear the counter on a periodic, aperiodic, event driven, or on-demand basis and wherein the summation unit is configured to adjust the bandwidth measurement by averaging at least two bandwidth measurements.

22. The apparatus according to claim 17 wherein the summation unit is further configured to sum the bandwidth for each user across multiple different users for respective determinations of total bandwidth for each user.

23. The apparatus according to claim 17 wherein the reporting unit is configured to report the total bandwidth.

24. The apparatus according to claim 17 further including:
a determination unit configured to determine whether the total bandwidth exceeds a limit configured for the user; and
a reporting unit configured to report a violation in an event the total bandwidth exceeds the limit.

25. The apparatus according to claim 17 further including:
a determination unit configured to determine whether the total bandwidth exceeds a limit; and
a flow control unit configured to disable further delivery of at least one multicast group to the user in an event the total bandwidth exceeds the limit.

26. The apparatus according to claim 17 further including:
a determination unit configured to determine whether the total bandwidth exceeds a limit; and
a flow control unit configured to disable flow of a most recently requested multicast group to the user in an event the total bandwidth exceeds the limit.

27. The apparatus according to claim 17 wherein the action processor is configured to issue an alarm or notification in an event the bandwidth for a requested multicast group is below a threshold, or above a threshold.

28. The apparatus according to claim 17 wherein the action processor is configured to issue an alarm or notification in an event the bandwidth for all requested multicast groups is below a threshold.

29. The apparatus according to claim 17 wherein the action processor is configured to reply to inquiries with an indication of the total bandwidth flowing to the user.

30. The apparatus according to claim 17 further including:
a filter unit configured to update a set of multicast groups sent to the user based on join or leave messages;
a monitor unit configured to associate a counter to each multicast group sent to the user;
a summation unit configured to access a record in a storage unit of the bandwidth of the multicast groups previously flowed to the user;
a determination unit configured to periodically sum bandwidth of all multicast groups requested by the user to determine the user's total bandwidth; and
a flow control unit configured to approve or reject the request as a function of a total bandwidth of the multicast groups to flow to the user if the request were to be approved.

31. The apparatus according to claim 17 wherein the apparatus is integrated with an Optical Network Terminal (ONT) in a Passive Optical Network (PON).

32. The apparatus according to claim 17 wherein the apparatus is integrated with a Digital Subscriber Line Access Multiplexer (DSLAM) in a Digital Subscriber Line (DSL) network.

33. A computer program product for monitoring multicast bandwidth to a user, the computer program product comprising a computer readable medium having computer readable instructions stored thereon, which, when loaded and executed by a processor, causes the processor to:
monitor quantity of a multicast group flowing to a user;
convert the quantity to bandwidth;
sum the bandwidth with bandwidth of other multicast groups flowing to the user to determine a total bandwidth flowing to the user; and
perform an action based on the total bandwidth.
